(19) United States
(12) Patent Application Publication
(10) Pub. No.: US 2025/0091532 A1
(43) Pub. Date: Mar. 20, 2025

(54) VEHICULAR COMPARTMENT SOUNDPROOFING STRUCTURE

(71) Applicants: TOYOTA BOSHOKU KABUSHIKI KAISHA, Aichi-ken (JP); NIHON TOKUSHU TORYO CO., LTD., Tokyo (JP)

(72) Inventors: Masahiro NAGANO, Aichi-ken (JP); Yuji WATANABE, Ibaraki-ken (JP); Hiroshi KAWAMURA, Tokyo (JP)

(73) Assignees: TOYOTA BOSHOKU KABUSHIKI KAISHA, Aichi-ken (JP); NIHON TOKUSHU TORYO CO., LTD., Tokyo (JP)

(21) Appl. No.: 18/729,530

(22) PCT Filed: Jan. 20, 2023
(86) PCT No.: PCT/JP2023/001722

§ 371 Date: Jul. 17, 2024

(30) Foreign Application Priority Data
Jan. 25, 2022 (JP) 2022-009166

(51) Int. Cl. B60R 13/08; G10K 11/172

(52) U.S. Cl. CPC B60R 13/08; G10K 11/172

(57) ABSTRACT

A first structure in which connection strength between an air impermeable layer and a compressed fiber layer is relatively low and a second structure in which connection strength between the air impermeable layer and the compressed fiber layer is higher than the connection strength of the first structure. A vehicular compartment soundproofing structure includes the second structure that has good soundproofing performance in a high frequency band (1000 Hz or higher) and the first structure that has improved soundproofing performance in a middle frequency band with suppressing lowering of insertion loss in the middle frequency band (200 Hz to 630 Hz). Accordingly, the soundproofing performance of a whole vehicular compartment can be improved.

### TECHNICAL FIELD

The present invention relates to a vehicular compartment soundproofing structure in a vehicular compartment for suppressing noise from outside.

### BACKGROUND ART

A soundproofing structure has been included in a partition member, which partitions a vehicular compartment, such that exterior noise or noise from a driving section of a vehicle is not transferred to the vehicular compartment. For example, an automotive trim part described in following Patent Document 1 has been known as a partition member having such a soundproofing structure. The automotive trim part includes a structure having mass-spring characteristics as a soundproofing structure on a vehicular interior side of a panel, which is a body of the partition member. Specifically, a sound absorbing layer (a decoupling layer) as a spring element, and an air impermeable layer (an air impermeable barrier layer) and a compressed fiber layer (a porous fiber layer) as a mass element are disposed on top of each other in this order from a panel side on a vehicular interior side surface of the panel. The automotive trim part described in Patent Document 1 is for sound proofing in a middle frequency band between the noise in a relatively low frequency band ranging from 50 Hz to 500 Hz and the noise in a high frequency band higher than 2 kHz. By adjusting the Young's modulus of the porous fiber layer, high sound insulation properties can be exerted in the middle frequency band. Patent Document 2 described below discloses that to primarily absorb sound, the porous fiber layer whose Young's modulus is adjusted is made thicker than the porous fiber layer provided primarily for insulating sound.

### PRIOR ART DOCUMENT

### Patent Document

[Patent Document 1] Japanese Translation of PCT International Application Publication No. JP-T-2013-522094
[Patent Document 1] Japanese Translation of PCT International Application Publication No. JP-T-2013-5221190

### SUMMARY OF THE PRESENT INVENTION

### Problem to be Solved by the Invention

In the above soundproofing structure described in Patent Documents 1 and 2, the barrier layer and the porous fiber layer are firmly connected and function as the mass element. As described before, in the soundproofing structure described in Patent Document 1, high sound insulating properties are exerted in the relatively high frequency band and the frequency band higher than the relatively high frequency band. However, in such a structure, the sound absorbing layer, which is included as the spring element, transfers relatively low frequency sound (about 200 Hz to 500 Hz) from the partition member in the vehicular compartment to the mass layer. Namely, resonance transmission (resonance) occurs. Therefore, soundproofing performance in the frequency band of 200 Hz to 630 Hz may be deteriorated.

The present invention has been made in view of the aforementioned circumstances. An object is to provide a vehicular compartment soundproofing structure including a structure that improves soundproofing performance with respect to sound in a frequency band ranging from 200 Hz to 630 Hz to improve soundproofing performance of a whole vehicular compartment.

### Means for Solving the Problem

To solve the above problem, a vehicular compartment soundproofing structure according to the present technology is included in a vehicular compartment for suppressing exterior noise and the vehicular compartment soundproofing structure includes
a partition member that partitions the vehicular compartment:
a sound absorbing layer disposed on a vehicular interior side with respect to the partition member and having spaces therein:
an air impermeable layer disposed on the vehicular interior side with respect to the sound absorbing layer and made of air impermeable material; and
a compressed fiber layer disposed on the vehicular interior side with respect to the air impermeable layer and mainly formed of a compressed mass of fibers.

The vehicular compartment soundproofing structure includes a first structure section in which connection strength between the air impermeable layer and the compressed fiber layer is relatively low and a second structure section in which connection strength between the air impermeable layer and the compressed fiber layer is higher than the connection strength between the air impermeable layer and the compressed fiber layer of the first structure section.

Generally, a soundproofing member is disposed on a vehicular interior side surface of a dashboard or floor panel, which are examples of the partition member as a component mainly partitioning the vehicular compartment. A spring mass model is used to evaluate the soundproofing performance of the soundproofing member with respect to the vehicular compartment. Specifically, the spring mass model includes a portion that is disposed on a vehicular interior side with respect to the partition member, which is a rigid member, and is made of low density material such as non-compressed felt and foaming material as a spring element and a portion that is disposed on the vehicular interior side with respect to the spring element and is made of high-density impermeable material as a mass element. The above structure including the spring mass and the rigid member, which corresponds to the partition member, has characteristics of a double wall structure that includes an air gap in between. The soundproofing performance of the partition member with respect to the vehicular compartment was evaluated based on insertion loss that represents difference between a sound pressure level without including a soundproofing member (the spring mass model) and a sound pressure level including a soundproofing member. Generally, in most configurations, the compressed fiber layer is bonded firmly to the air impermeable layer. In such configurations, the air impermeable layer and the compressed fiber layer act as the mass element and resonance (resonance transmission) occurs in a middle frequency band and the insertion loss drops.

According to the vehicular compartment soundproofing structure of the present technology, the connection strength between the compressed fiber layer and the air impermeable layer in the first structure section is lower than the connection strength between the compressed fiber layer and the air impermeable layer in the second structure section. Namely, in the soundproofing structure of the first structure section, sound is less likely to be transferred from the air impermeable layer to the compressed fiber layer. In detail, resonance occurs between the partition member and the air impermeable layer itself and the mass layer is decreased in weight. Accordingly, the frequency of the resonance shifts to the high frequency side. Therefore, in the first structure section, the insertion loss in the middle frequency band can be improved and the soundproofing performance in the middle frequency band can be improved compared to the second structure section. With the connection strength between the compressed fiber layer and the air impermeable layer being decreased, the soundproofing performance in the high frequency band is lowered compared to the configuration in which the connection strength between the compressed fiber layer and the air impermeable layer is high.

The vehicular compartment soundproofing structure included in the partition member that partitions the vehicular compartment includes a portion having relatively high soundproofing performance in the middle frequency band and a portion having relatively low sound proofing performance due to different configurations of the partition members and different thicknesses of the second absorbing layers of the partition members having different configurations. For example, the portion having relatively low soundproofing performance in the middle frequency band is defined as the first structure section and the portion having relatively high soundproofing performance in the middle frequency band is defined as the second structure section. With the vehicular compartment soundproofing structure having the above configuration, the second structure section can have improved soundproofing performance in the high frequency band and the first structure section can primarily have soundproofing performance in the middle frequency band. Thus, the soundproofing performance of the whole vehicular compartment can be improved. In the vehicular compartment soundproofing structure with this configuration, the phrase “the connection force is decreased” or “the adhesion force is decreased” means decreasing the connection force in the first structure section by partially bonding the air impermeable layer and the compressed fiber layer with portions of dots or lines or reducing the amount of adhesive, or changing the type of the adhesive unlike the second structure section in which the air impermeable layer and the compressed layer are bonded with entire surfaces thereof. The phrase “the connection force is decreased” does not necessarily mean the layers are bonded in the first structure section but includes configuration in which the adhesion force is zero or the layers are not bonded.

“The compressed fiber layer” of the vehicular compartment soundproofing structure is made of natural fibers or synthetic fibers and is a mass of fibers of felt or glass wool. For example, wool fibers are piled in a thin layer then adding heat and alkali and mixing under pressure. Accordingly, wool fibers are milled and interlocked with each other and a compressed felt is obtained. Such a compressed felt can be used as the compressed fiber layer. The porous fiber layer with adjusted Young's modulus described in Patent Document 1 can be used.

“The sound absorbing layer” is a so-called silencer and may be made of a mass of fibers having spaces therein or porous synthetic resin such as urethane foam. The sound absorbing layer preferably has a thickness of 3 mm to 60 mm. Furthermore, “the air impermeable layer” is a film including a single layer or multiple layers made of polyethylene, polypropylene, polyester, polyamide, ionomer resin, polyvinyl chloride, polyvinylidene chloride, polyvinyl alcohol, polystyrene, EVA, EVOH, and EMMA.

In the above configuration, the partition member may be a floor panel that defines a floor of an automobile, the first structure section may be provided on a portion of the floor panel corresponding to a foot space where feet of a seated occupant are placed and the second structure section may be provided on portions of the floor panel other than the foot space, and the sound absorbing layer of the first structure section may be thicker than the sound absorbing layer of the second structure section.

Unlike the portions of the vehicular compartment soundproofing structure on which heavy components such as a seat and a center console are disposed and that are covered by such components, the vehicular compartment soundproofing structure is likely to be uncovered in foot spaces in the automobile. To increase the insertion loss in the foot spaces, for example, the thickness of the sound absorbing layer is preferably increased compared to other portions. As the thickness of the sound absorbing layer is increased, the sound pressure level in the middle frequency band tends to be increased due to the resonance transmission. The vehicular component soundproofing structure having the configuration is used on the floor of vehicles such as automobiles or trucks. The soundproofing performance in the middle frequency band is primarily achieved in the foot space where the sound pressure level in the middle frequency band is high, and the soundproofing performance in the high frequency band is ensured in the portions other than the foot space where the sound pressure level in the middle frequency band is low. Thus, the soundproofing performance of the whole vehicular compartment can be improved.

In the above configuration, a mass per unit area of the air impermeable layer may be 15 gsm or more and 400 gsm or less and preferably 50 gsm or more and 200 gsm or less.

In the vehicular compartment soundproofing structure having the above configuration, the basis weight of the air impermeable layer is relatively low. As the basis weight of the air impermeable layer is lower, the resonance frequency of the resonance transmission (resonance transmission frequency) shifts to higher frequency side. Therefore, according to the vehicular compartment soundproofing structure having the above configuration, the soundproofing performance in the middle frequency band (particularly 315 Hz to 500 Hz) can be further improved.

In the above configuration, a mass per unit area of the compressed fiber layer may be 300 gsm or more and 1500 gsm or less and preferably 600 gsm or more and 1000 gsm or less.

In the vehicular compartment soundproofing structure having the above configuration, the basis weight of the compressed fiber layer is defined and effective soundproofing performance can be obtained without increasing the thickness of the compressed fiber layer.

In the above configuration, in the first area, the air impermeable layer and the compressed fiber layer may not be bonded.

In the vehicular compartment soundproofing structure having the above configuration, synthetic vibration of the air impermeable layer caused by the resonance transmission is less likely to be transferred to the compressed fiber layer and the soundproofing performance in the middle frequency band can be effectively improved.

### Advantageous Effect of the Invention

According to the present invention, a vehicular compartment soundproofing structure that improves soundproofing performance of a whole vehicular compartment is provided.

### BRIEF DESCRIPTION OF THE DRAWINGS

FIG. 1 is a perspective view of a vehicular floor panel on which a vehicular floor structure according to a first embodiment is provided.

FIG. 2A is a plan view of the floor panel illustrated in FIG. 1.

FIG. 2B is an upper view of the floor panel including the vehicular floor structure according to the first embodiment.

FIG. 3 is a cross-sectional view schematically illustrating a floor structure of a first area.

FIG. 4 is a cross-sectional view schematically illustrating a floor structure of a second area.

FIG. 5 is a cross-sectional view schematically illustrating a floor structure of a comparative example.

FIG. 6 illustrates a spring mass model of the floor structure of FIGS. 4 and 5.

FIG. 7 illustrates a spring mass model of the floor structure of FIG. 3.

FIG. 8 is a graph illustrating relation of frequencies and insertion losses of each floor structure.

FIG. 9 is a graph illustrating relation of ⅓ octave band frequencies and sound sensitivity in the vehicular floor structure of the first embodiment and the floor structure of the comparative example.

FIG. 10 is a graph illustrating relation of a thickness of the whole floor structure and resonance frequencies.

FIG. 11 is a cross-sectional view schematically illustrating a floor structure of the first area of a vehicular floor structure of a second embodiment.

FIG. 12 is a cross-sectional view schematically illustrating a floor structure of the second area of the vehicular floor structure of the second embodiment.

FIG. 13 illustrates a spring mass model of the floor structure of FIG. 12.

FIG. 14 is a graph illustrating relation of frequencies and insertion losses of each floor structure.

FIG. 15 is a graph illustrating change of the insertion loss with mass per unit area of the air impermeable layer being changed.

### MODES FOR CARRYING OUT THE INVENTION

### First Embodiment

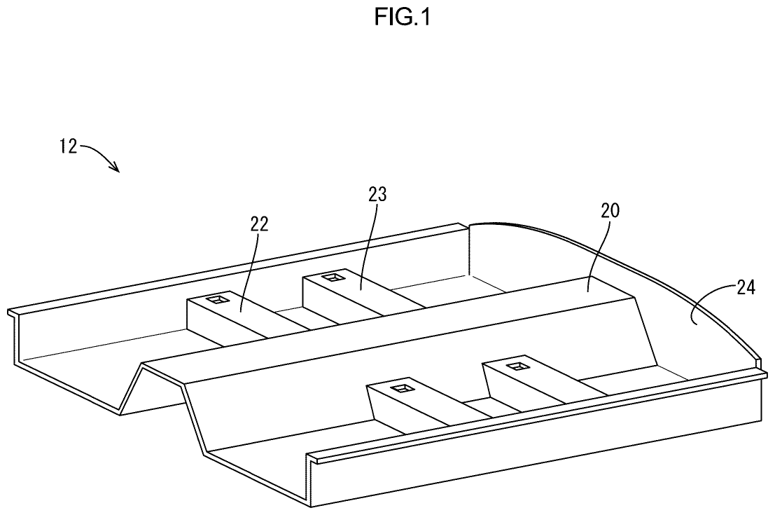

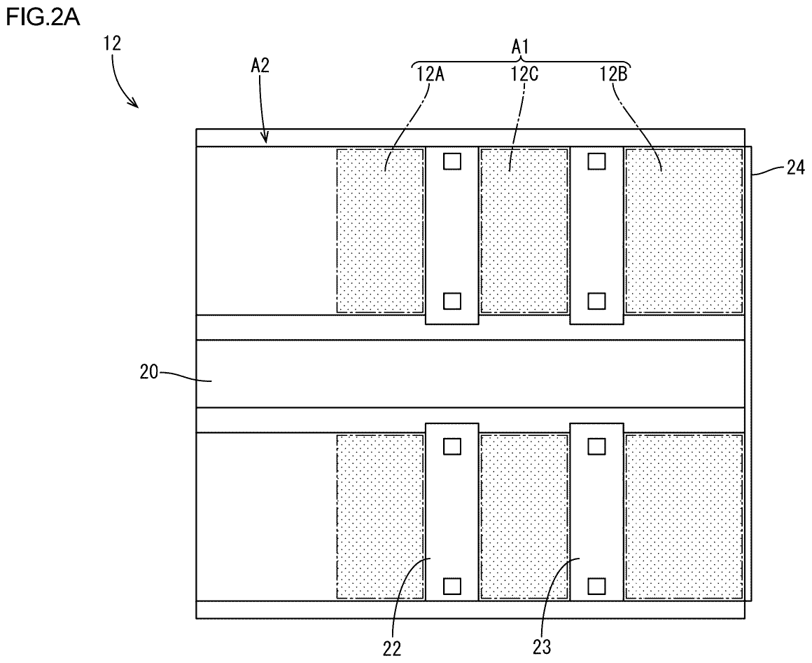

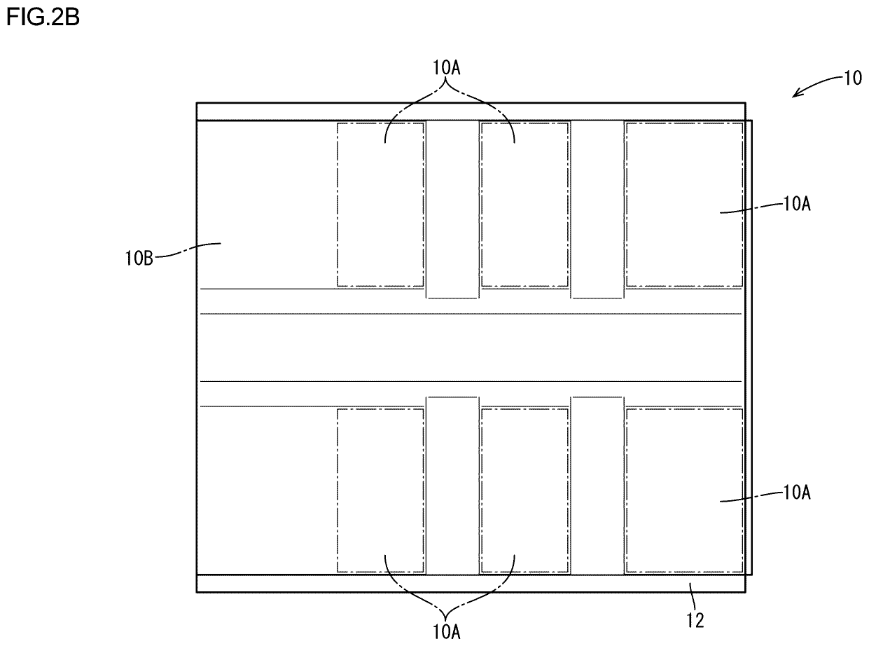

A vehicular compartment soundproofing structure according to this embodiment is included in a floor of a vehicle (an automobile). A vehicular floor structure 10 according to this embodiment will be described. The vehicular floor structure 10 includes a floor panel 12 illustrated in FIGS. 1 and 2A, and a floor silencer 14 and a carpet 16 that are arranged on the floor panel 12. The floor panel 12 is a partition member that defines a floor of a vehicular compartment. The floor panel 12 is made of metal and has a rectangular plan view shape elongated in a vehicular front-rear direction.

As illustrated in FIGS. 1 and 2A, the floor panel 12 includes a floor tunnel 20 in a middle with respect to a vehicular width direction. The floor tunnel 20 extends in the vehicular front-rear direction and projects upward. The vehicle includes two reinforcing members that extend in the vehicular width direction. The floor panel 12 includes a front projection portion 22 and a rear projection portion 23 that project upward to have a shape such that the two reinforcing members are fitted in the front projection portion 22 and the rear projection portion 23. In the vehicle, a driver's seat and a passenger seat are disposed above the front projection portion 22 and the rear projection portion 23. The floor panel 12 includes a wall 24 at a rear edge. In the vehicle, a rear seat is disposed behind the wall 24. The floor panel 12 includes an area 12A that is in front of the front projection portion 22 and an area 12B that is between the wall 24 and the rear projection portion 23. Vehicle occupants who are seated put their feet in the areas 12A and 12B, which are foot spaces.

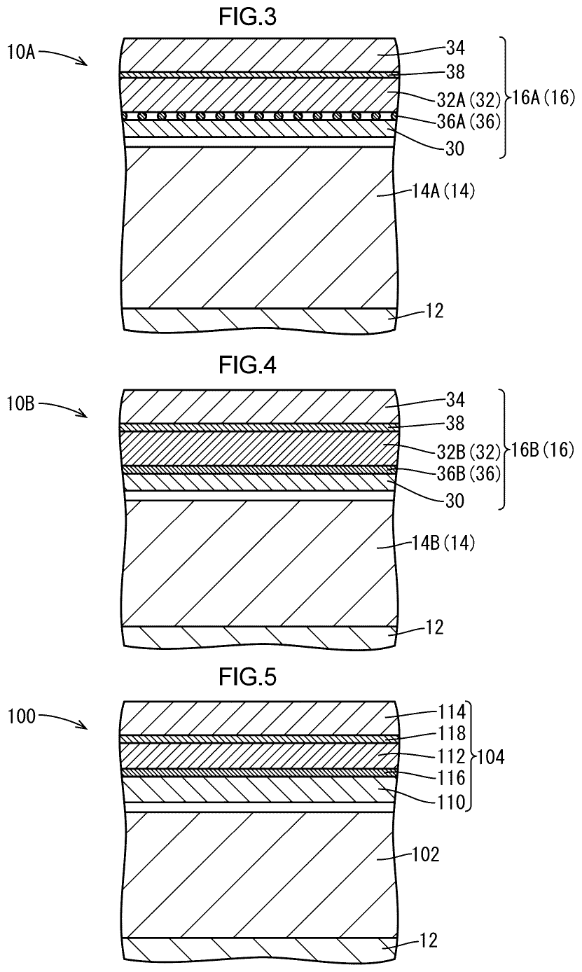

The floor panel 12 further includes an area 12C that is between the front projection portion 22 and the rear projection portion 23. As illustrated in FIG. 2B, the vehicular floor structure 10 of this embodiment includes a first floor structure 10A and a second floor structure 10B. The first floor structure 10A is provided in the areas 12A, 12B, which are foot spaces as previously described, and the area 12C. The second floor structure 10B is provided in a second area A2 of the floor panel 12, which is an area other than the areas 12A, 12B, 12C. The first floor structure 10A differs from the second floor structure 10B. The first floor structure 10A illustrated in FIG. 3 and the second floor structure 10B illustrated in FIG. 4 will be described below. Furthermore, difference between the first floor structure 10A and the second floor structure 10B will be described in detail.

A floor silencer 14 is disposed on the floor panel 12. The floor silencer 14 is made of mass of fibers including spaces therein and porous synthetic resin such as urethane foam. In this embodiment, the floor silencer 14 is a felt made of thermoplastic resin fiber. The floor silencer 14 is disposed on a vehicular interior side surface of the floor panel 12, which is included as the partition member, and functions as a sound absorbing layer including multiple spaces therein. Unlike the portions of the floor structure 10 on which heavy components such as a seat and a center console are disposed and that are covered by such components, the floor structure 10 is likely to be uncovered in the area 12A and the area 12B, which are foot spaces. To increase the insertion loss in the areas 12A, 12B, which are foot spaces, for example, the thickness of the portion of the floor silencer 14 that corresponds to the foot space is preferably increased compared to other portions. Therefore, the thickness of a floor silencer 14A that corresponds to the areas 12A, 12B, which are the foot spaces, and the area 12C (a first area A1), which is between the front projection portion 22 and the rear projection portion 23, is greater than the thickness of the floor silencer 14 corresponding to other area. Namely, the thickness of the floor silencer 14A included in the first floor structure 10A is greater than the thickness of the floor silencer 14B included in the second floor structure 10B. In this embodiment, the thickness of the floor silencer 14A included in the first floor structure 10A is about 20 mm and the thickness of the floor silencer 14B included in the second floor structure 10B is about 10 mm. The thickness of the floor silencers 14A, 14B is preferably from 3 mm to 60 mm to absorb sound transferred from the outside of the floor panel 12.

The vehicular floor structure 10 of this embodiment is characterized in the difference of a configuration of the carpet 16 included in the first floor structure 10A and a configuration of the carpet 16 included in the second floor structure 10B. Therefore, in evaluating the soundproofing performance of the first floor structure 10A and the second floor structure 10B, the floor silencer having the same thickness is used in the both structures.

The carpet 16 is disposed on the floor silencer 14. As illustrated in FIGS. 3 and 4, the carpet 16 includes an air impermeable layer 30, a compressed fiber layer 32, and a skin layer 34 that are disposed on top of each other in this order from a floor silencer 14 side (a vehicular exterior side). The air impermeable layer 30 and the compressed fiber layer 32 are bonded with adhesive and the compressed fiber layer 32 and the skin layer 34 are bonded with adhesive and adhesive layers 36, 38 are formed.

The air impermeable layer 30 is a film made of air impermeable material. The air impermeable layer 30 is disposed on the vehicular interior side with respect to the floor silencer 14, which is a sound absorbing layer, and is for mainly shielding outside sound. The air impermeable layer 30 is a film including a single layer or multiple layers made of polyethylene, polypropylene, polyester, polyamide, ionomer resin, polyvinyl chloride, polyvinylidene chloride, polyvinyl alcohol, polystyrene, EVA, EVOH, and EMMA. Mass per unit area of the air impermeable layer 30 is 15 gsm or more and 400 gsm or less, and preferably 50 gsm or more and 200 gsm or less. In this embodiment, the air impermeable layer 30 is a single layer film made of polyethylene and mass per unit area of the air impermeable layer 30 is 100 gsm.

The compressed fiber layer 32 is disposed on the vehicular interior side with respect to the air impermeable layer 30 and is for absorbing sound and shielding sound. The compressed fiber layer 32 may be a so-called compressed felt that is obtained by felting natural fiber, synthetic fiber, or mixed fiber thereof with binder fiber. The compressed felt is preferably made of recycled fiber material such as regenerated cotton or synthetic recovered fiber, which is regenerated fiber such as polyester. For example, the compressed fiber layer 32 is obtained by mixing polyester having a low melting point with synthetic recovered fiber as a binder and heating mass of the mixture and forming into a desired mat shape with pressing. However, because the vehicular interior space is limited, the thickness of the compressed fiber layer 32, which is mass per unit area of the compressed fiber layer 32, is preferably smaller. With considering the above matter, the compressed fiber layer 32 is 300 gsm ore more and 1500 gsm or less, and preferably 600 gsm and more and 1000 gsm or less. In this embodiment, mass per unit area of the compressed fiber layer 32 is 800 gsm both in the first floor structure 10A and the second floor structure 10B.

The compressed fiber layer 32 has different configurations between the first floor structure 10A and the second floor structure 10B. Specifically, the compressed fiber layer 32 includes a first compressed fiber layer 32A and a second compressed fiber layer 32B. The first compressed fiber layer 32A is included in the first floor structure 10A and is a general compressed felt that is produced as described above. The second compressed fiber layer 32B is included in the second floor structure 10B and Young's modulus of the second compressed fiber layer 32B is adjusted. The second compressed fiber layer 32B is increased in the soundproofing performance in the high frequency band (1000 Hz to 8000 Hz). Details will be described later.

The skin layer 34 may not be limited to a particular one and may be various kinds of skins such as a dilour skin, a velours skin, a plain skin, and a tufted carpet skin. In this embodiment, the skin layer is a dilour skin and mass per unit area of the skin layer is 350 gsm. The first floor structure 10A and the second floor structure 10B include the skin layer 34 having a same configuration.

The adhesive layers 36, 38 may be liquid adhesive or may be solid adhesive such as an adhesive film or an adhesive tape. Both of the first floor structure 10A and the second floor structure 10B include the adhesive layer 38 between the compressed fiber layer 32 and the skin layer 34. The skin layer 34 is bonded to the compressed fiber layer 32. The adhesive layer 38 is not necessarily included and the skin layer 34 may not be bonded to the compressed fiber layer 32.

On the other hand, the adhesion strength of the adhesive layer 36 that is disposed between the air impermeable layer 30 and the compressed fiber layer 32 differs between the first floor structure 10A and the second floor structure 10B. The adhesive layer 36 includes a first adhesive layer 36A that is included in the first floor structure 10A and a second adhesive layer 36B that is included in the second floor structure 10B. The adhesion strength of the first adhesive layer 36A is lower than the second adhesive layer 36B. Specifically, for example, the second adhesive layer 36B is disposed on an entire area of the air impermeable layer 30 and the second compressed fiber layer 32B in the second area A2. On the other hand, the first adhesive layer 36A is formed in a dot shape or a line shape for partial bonding. The adhesion strength of the first adhesive layer 36A may be decreased with any particular method but may be decreased by reducing the amount of liquid adhesive used for the first adhesive layer 36A compared to that for the second adhesive layer 36B or using different types of adhesive.

As previously described, the vehicular floor structure 10 of this embodiment includes the first floor structure 10A (a first structure section) that is provided corresponding to the first area A1 including the areas 12A, 12B, 12C and the second floor structure 10B (a second structure section) that is provided corresponding to the second area A2 that is an area other than the first area A1. The connection strength (adhesion strength) of the air impermeable layer 30 and the compressed fiber layer 32A included in the first floor structure 10A is relatively low. The connection strength (adhesion strength) of the air impermeable layer 30 and the compressed fiber layer 32B included in the second floor structure 10B is higher than the connection strength (adhesion strength) of the air impermeable layer 30 and the compressed fiber layer 32A included in the first floor structure 10A. As illustrated in FIG. 3, the carpet 16A corresponding to the first area A1 includes the skin 34, the adhesive layer 38, the compressed fiber layer 32A, the adhesive layer 36A, and the air impermeable layer 30. As illustrated in FIG. 4, the carpet 16B corresponding to the second area A2 includes the skin 34, the adhesive layer 38, the compressed fiber layer 32B, the adhesive layer 36B, and the air impermeable layer 30. In the following, the soundproofing performance of the first floor structure 10A in the first area A1 and the second floor structure 10B in the second area A2 will be described. Before describing the soundproofing performance of the vehicular floor structure 10, a general configuration of a vehicular floor structure 100 (a soundproofing structure) of a comparative example will be described with reference to FIG. 5.

The vehicular floor structure 100 according to the comparative example includes a floor silencer 102 and a carpet 104. The floor silencer 102 is similar to the floor silencer 14 of this embodiment. The carpet 104 includes a backing layer 110 (an air impermeable layer) made of polyethylene, a compressed fiber layer 112 made of compressed felt, and a skin layer 114, which is a dilour skin, from a lower layer side (a floor silencer 102 side). The carpet 104 further includes adhesive layers 116, 118, which include adhesive, between the layers and the layers are bonded to each other. The vehicular floor structure 100 of the comparative example is similar to the second floor structure 10B in the second area A2 illustrate in FIG. 4.

However, mass per unit area of the backing layer 110 of the carpet 104 is greater than that of the air impermeable layer 30 of this embodiment and is 600 gsm. The compressed fiber layer 112 is made of compressed felt similar to the first compressed fiber layer 32A: however, mass per unit area of the compressed fiber layer 112 is smaller than that of the compressed fiber layer 32 of this embodiment and is 300 gsm. Unlike this embodiment, the vehicular floor structure 100 does not include two different types of floor structures.

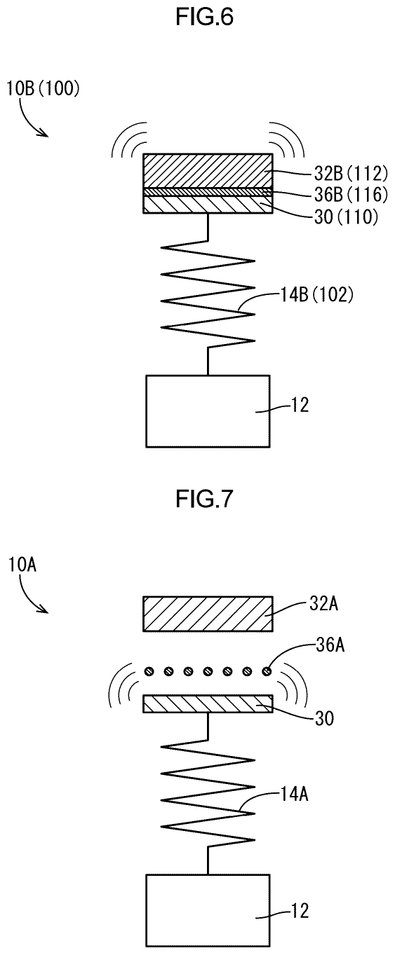

With respect to the evaluation of the soundproofing performance of each of the first floor structure 10A, the second floor structure 10B, and the floor structure 100 of the comparative example, an actual vehicle evaluation experiment was performed with using test pieces and estimation is performed with using a simulation software. The simulation was performed with using the spring mass models illustrated in FIGS. 6 and 7. Specifically, the spring mass model used for the second floor structure 10B and the floor structure 100 of the comparative example is illustrated in FIG. 6 and the spring mass model used for the first floor structure 10A is illustrated in FIG. 7. The evaluation of the soundproofing performance was performed with the configuration without including the skin layer 34. The soundproofing performance of each floor structure was evaluated based on insertion loss that represents difference between a sound pressure level without including a soundproofing member (the spring mass model) and a sound pressure level including a soundproofing member.

The spring element of the spring mass model corresponds to a portion that is disposed on a vehicular interior side with respect to the floor panel 12, which is a rigid member, and is made of low density material such as non-compressed felt and foaming material. In both floor structures, the floor silencers 14, 102 correspond to the spring element. The mass element corresponds to a portion that is disposed on the vehicular interior side with respect to the spring element and is made of high-density impermeable material. In the second floor structure 10B, since the second compressed fiber layer 32B is firmly bonded to the air impermeable layer 30 with the second adhesive layer 36B, the air impermeable layer 30 and the second compressed fiber layer 32B correspond to the mass element. Similar to the second floor structure 10B, in the floor structure 100 of the comparative example, the backing layer 110, which is an air impermeable layer, and the compressed fiber layer 112 correspond to the mass element.

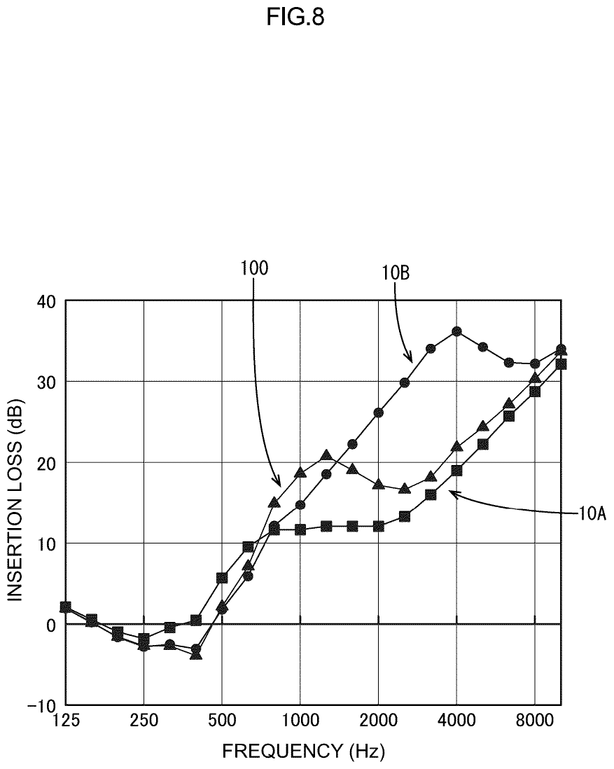

As illustrated in FIG. 8, comparing the insertion loss of the floor structure 100 of the comparative example and the insertion loss of the second floor structure 10B, the second floor structure 10B exerts higher soundproofing performance than the floor structure 100 of the comparative example in the high frequency band (1000 Hz to 8000 Hz) due to the effects of the second compressed fiber layer 32B whose Young's modulus is adjusted. On the other hand, the above floor structures, which include the spring mass and the floor panel 12, have characteristics of the double wall structure that includes an air gap in between. Transfer of relatively low frequency sound (about 200 Hz to 500 Hz) to the mass layer, which is so-called resonance transmission (resonance), occurs between the floor panel 12 and the mass element. Therefore, as illustrated in FIG. 8, the insertion loss drops in a middle frequency band (315 Hz to 630 Hz). The resonance transmission frequency f where the resonance transmission occurs can be calculated with a formula 1. In the formula 1, m₁ represents a weight per unit area of the floor panel 12, m₂ represents a weight per unit area of the mass element, E represents Young's modulus of the spring element (air), and d represents a thickness of the spring element. In this embodiment, the resonance transmission frequency is 454 Hz and it can be confirmed in FIG. 8 that the insertion loss is lowest.

$$f = \frac{1}{2 π} \sqrt{\frac{{m}_{1} + {m}_{2}}{{m}_{1} \cdot {m}_{2}} \cdot \frac{E}{d}} \qquad [ Formula 1 ]$$

On the other hand, in the first floor structure 10A, the adhesion strength between the air impermeable layer 30 and the first compressed fiber layer 32A is weakened (is almost in a non-adhered state) compared to the adhesion strength in the second floor structure 10B. Therefore, as illustrated in FIG. 7, the vibration of the air impermeable layer 30 is less likely to be transferred to the first compressed fiber layer 32A. Since almost only the air impermeable layer 30 corresponds to the mass element, the weight of the mass element is reduced. With respect to the first floor structure 10A, the resonance frequency calculated with the formula 1 is on a higher frequency side than the resonance transmission frequency of the second floor structure 10B and the floor structure 100 of the comparative example. In this embodiment, the calculated resonance frequency of the first floor structure 10A is 1343 Hz. As illustrated in FIG. 8, the insertion loss decreases in the high frequency band (1000 Hz to 3000 Hz); however, the resonance transmission is less likely to occur in the middle frequency band (315 Hz to 630 Hz) and the insertion loss is less likely to be reduced. Namely, compared to the second floor structure 10B, the soundproofing performance of the first floor structure 10A is lowered in the high frequency band but is less likely to be lowered in the middle frequency band.

In the vehicular floor structure 10 of this embodiment, the first floor structure 10A that causes less lowering of the soundproofing performance in the middle frequency band is used for the portion corresponding to the first area A1 in which the floor silencer 14 has a relatively great thickness and the sound absorbing performance in the high frequency band is good, and the second floor structure 10B that is good in the soundproofing performance in the high frequency band is used for the portion corresponding to the second area A2 in which the floor silencer 14 has a relatively small thickness. Therefore, with the vehicular floor structure 10, the soundproofing performance of the vehicular compartment as a whole can be improved.

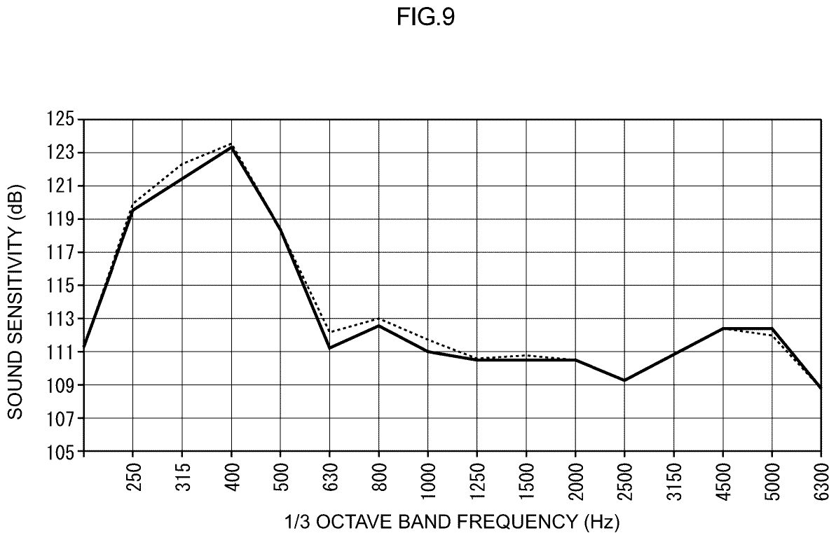

Sound sensitivity near the head of the passenger who is seated on a vehicular rear seat is illustrated in FIG. 9. A solid line represents sound sensitivity with the vehicular floor structure 10 of this embodiment and a dotted line represents sound sensitivity with a configuration in which the floor structure 100 of the comparative example is used for an entire area of the floor panel 12. As is obvious from FIG. 9, it was confirmed that the soundproofing performance is improved in a wide frequency band ranging from 250 Hz to 2000 Hz with the vehicular floor structure 10 of this embodiment compared to the floor structure 100 of the comparative example.

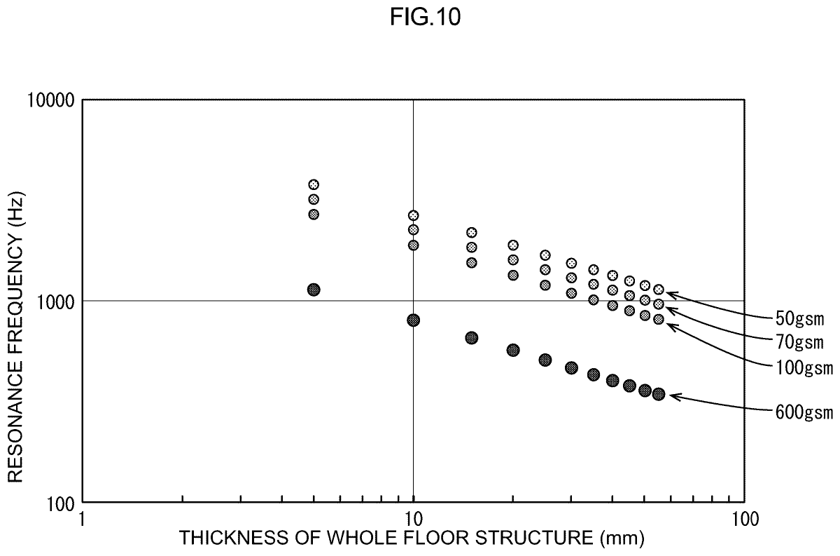

FIG. 10 illustrates relation of the thickness of the whole floor structure and the resonance frequency with the mass per unit area (basis weight) of the air impermeable layer being changed in the first floor structure 10A. As is obvious from FIG. 10, as the basis weight of the air impermeable layer is reduced, the resonance frequency shifts towards the high frequency side (upward in FIG. 10) regardless of the thickness of the floor silencer. Namely, as the resonance frequency shifts toward the high frequency side, less influence is exerted on the middle frequency band. Therefore, lowering of the soundproofing performance in the middle frequency band is suppressed. Therefore, it is desirable to reduce the basis weight of the air impermeable layer in the first floor structure 10A.

### Second Embodiment

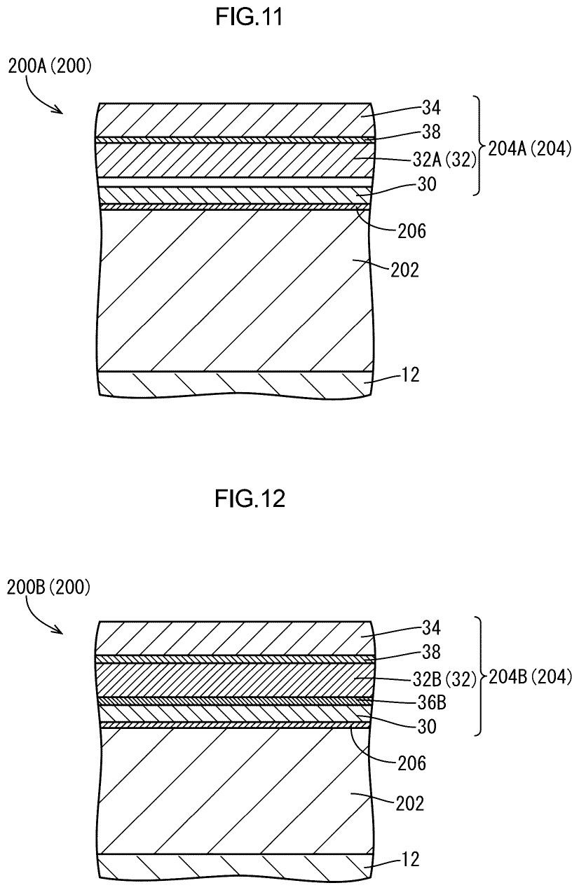

A vehicular floor structure 200 of a second embodiment has a configuration similar to that of the vehicular floor structure 10 of the first embodiment. The same symbols as those of the first embodiment are used for the configuration same as that of the first embodiment and the same configuration is simply described or not described. The vehicular floor structure 200 of the second embodiment includes a floor silencer 202 and a carpet 204 similar to the vehicular floor structure 10 of the first embodiment: however, a configuration of a portion of the carpet 204 corresponding to the first area A1 differs from that of the first embodiment. In the vehicular floor structure 10 of the first embodiment, the air impermeable layer 30 and the first compressed fiber layer 32A are bonded with relatively low adhesion strength in the first floor structure 10A corresponding to the first area A1. On the other hand, in the vehicular floor structure 200 of the second embodiment, as illustrated in FIG. 11, the air impermeable layer 30 and the first compressed fiber layer 32A are not bonded in a first floor structure 200A corresponding to the first area A1. As illustrated in FIG. 12, a second floor structure 200B corresponding to the second area A2 includes a second adhesive layer 36B between the air impermeable layer 30 and the second compressed fiber layer 32B. As illustrated in FIG. 11, the first floor structure 200A corresponding to the first area A1 does not include an adhesive layer between the air impermeable layer 30 and the first compressed fiber layer 32A. According to the vehicular floor structure 200 of this embodiment, in the first floor structure 200A, vibration is not transferred from the air impermeable layer 30 to the first compressed fiber layer 32A and lowering of the soundproofing performance in the middle frequency band is more surely suppressed. As illustrated in FIG. 11, the carpet 204A of the first floor structure 200A includes the skin 34, the adhesive layer 38, the compressed fiber layer 32A, and the air impermeable layer 30. As illustrated in FIG. 12, the carpet 204B of the second floor structure 200B includes the skin 34, the adhesive layer 38, the compressed fiber layer 32B, the adhesive layer 36B, and the air impermeable layer 30.

In the vehicular floor structure 200 of the second embodiment, the carpet 204 is bonded to an entire area of the floor silencer 202. Namely, as illustrated in FIGS. 11 and 12, both of the first floor structure 200A and the second floor structure 200B includes the adhesive layer 206 between the air impermeable layer 30 and the floor silencer 202 and the air impermeable layer 30 and the floor silencer 202 are bonded. In the first floor structure 200A, the connection strength between the compressed fiber layer 32A and the air impermeable layer 30 is lower than the connection strength between the air impermeable layer 30 and the floor silencer 202.

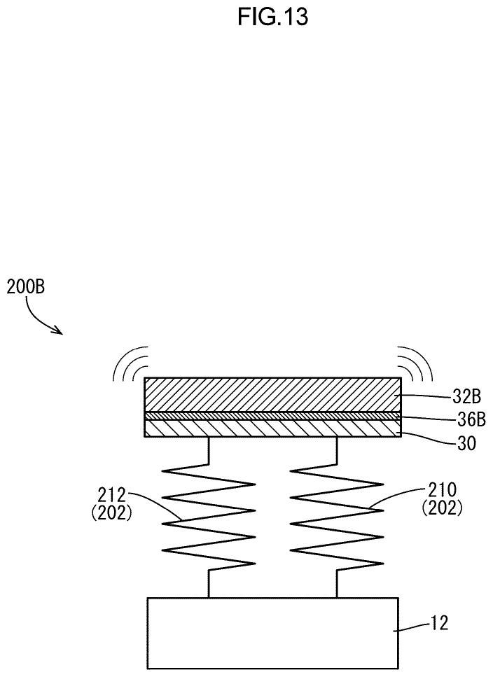

In each of the first floor structure 200A and the second floor structure 200B, the effects obtained by the configuration in which the air impermeable layer 30 and the floor silencer 202 are bonded will be described. First, the second floor structure 200B and the second floor structure 10B of the first embodiment are compared. It is considered that the second floor structure 200B of the second embodiment corresponds to a spring mass model illustrated in FIG. 13. Similar to the first embodiment, resonance due to resonance transmission (may be referred to as resonance by an air spring 210) that is characteristics of the double wall structure that includes an air gap in between is caused by the air included in the floor silencer 202. Furthermore, since the floor silencer 202 and the air impermeable layer 30 are bonded with the adhesive layer 206, resonance of the mass element (the air impermeable layer 30) is also caused by stretching of the floor silencer 202 in the thickness direction (may be referred to as resonance by stretching of a sound absorber 212).

The resonance frequency v of the resonance by stretching of the sound absorber 212 can be calculated with the following formula 2. In the formula 2, t represents a thickness of the floor silencer 202 that is a compressed felt, E represents Young's modulus of the compressed felt (the floor silencer 202), m₁ represents a weight per unit area of the floor panel 12, m₂ represents a weight per unit area of the mass element (the air impermeable layer 30), and m represents a weight per unit area of the compressed felt (the floor silencer 14B). The resonance frequency is 206 Hz in this embodiment.

$$v = \frac{1}{2 π} \sqrt{\frac{\frac{E}{t} ( {m}_{1} + {m}_{2} + m )}{{m}_{1} \cdot {m}_{2} + ( {m}_{1} + {m}_{2} ) \frac{m}{3} + \frac{{m}^{2}}{12}}} \qquad [ formula 2 ]$$

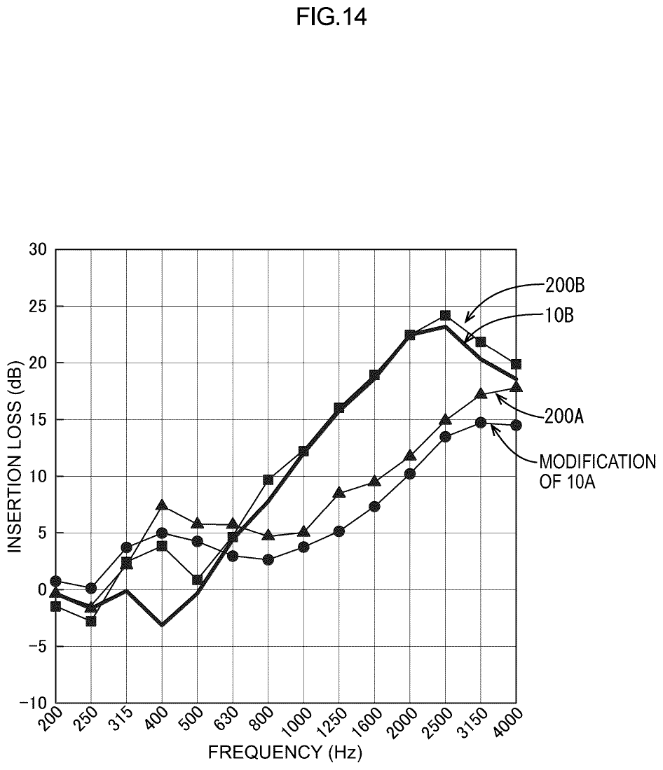

A solid line in FIG. 14 represents insertion loss of the second floor structure 10B of the first embodiment and a line connecting the squares in FIG. 14 represents insertion loss of the second floor structure 200B. The resonance frequency of the resonance by stretching of the sound absorber 212 is in the frequency band that is close to the resonance frequency of the resonance by the air spring 210 and the phases are reversed between the two resonance frequencies and antiresonance arises. Accordingly, as illustrated in FIG. 14, the insertion loss of the second floor structure 200B is increased in the frequency band from 250 Hz to 500 Hz and the soundproofing performance is improved.

Next, effects of the first floor structure 200A will be described. The line connecting the triangles in FIG. 14 represents insertion loss of the first floor structure 200A. The line connecting the circles in FIG. 14 represents insertion loss of a modification of the first floor structure 10A of the first embodiment. In the floor structure of the modification, similar to the first floor structure 10A, the air impermeable layer and the floor silencer are not bonded. Further, in the floor structure of the modification, the air impermeable layer 30 and the first compressed fiber layer 32A are not bonded and the soundproofing performance similar to (or better than) the first floor structure 10A of the first embodiment is exerted. Similar to the first floor structure 10A of the first embodiment, in the first floor structure 200A of the second embodiment and the floor structure of the modification, as the resonance frequency of the resonance by the air spring 210 shifts toward the high frequency side, lowering of the soundproofing performance in the middle frequency band is suppressed compared to the floor structure 100 of the comparative example. Furthermore, in the first floor structure 200A of the second embodiment, antiresonance also arises between the resonance frequency of the resonance by the air spring 210 and the resonance frequency of the resonance by stretching of the sound absorber 212. As illustrated in FIG. 14, in the first floor structure 200A of the second embodiment, due to the synergetic effects, improvement of the insertion loss was confirmed in a wide frequency band (315 Hz or higher) ranging from the middle frequency band to the high frequency band compared to the floor structure of the modification. The similar tendency was confirmed by the estimation performed with using the simulation software.

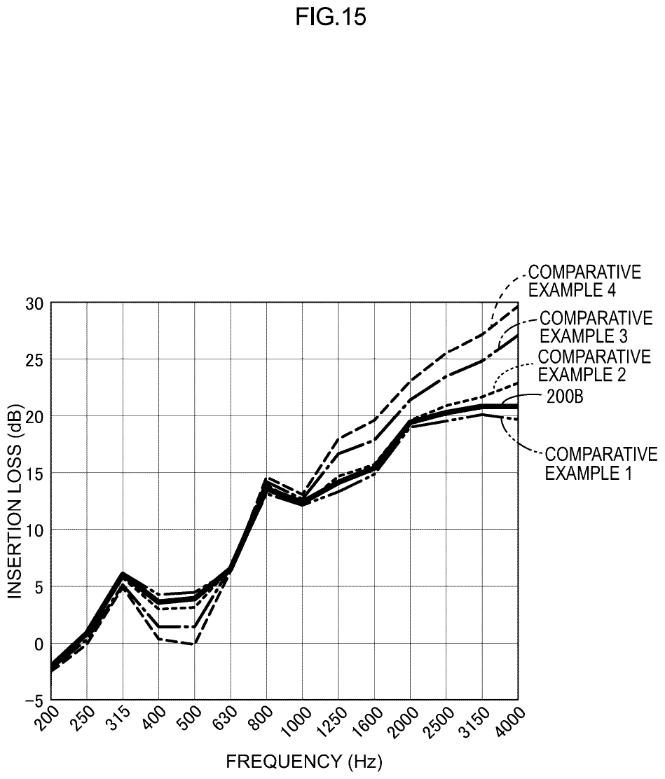

Next, in the second floor structure 200B of the second embodiment, with changing the weight ratio of the air impermeable layer and the compressed fiber layer and without changing the weight of the whole mass element, the insertion losses of the two kinds of second floor structures 200B were compared. Specifically, in addition to the second floor structure 200B of the second embodiment including 800 gsm of the compressed fiber layer and 100 gsm of the air impermeable layer, Comparative Example 1 including 850 gsm of the compressed fiber layer and 50 gsm of the air impermeable layer, Comparative Example 2 including 700 gsm of the compressed fiber layer and 200 gsm of the air impermeable layer, Comparative Example 3 including 500 gsm of the compressed fiber layer and 400 gsm of the air impermeable layer, and Comparative Example 4 including 300 gsm of the compressed fiber layer and 600 gsm of the air impermeable layer were prepared and the insertion losses of the comparative examples were calculated with the simulation software. As illustrated in FIG. 15, as the basis weight of the air impermeable layer is reduced, it was confirmed that the insertion loss is reduced in the high frequency band (1000 Hz or higher) and the insertion loss is increased in the middle frequency band (315 Hz to 630 Hz) and the soundproofing performance in the middle frequency band is improved. Accordingly, in the second floor structure 200B, the mass per unit area of the air impermeable layer is preferably 50 gsm or more and 200 gsm or less. Namely, in both of the first floor structure 200A and the second floor structure 200B, it was confirmed that the basis weight of the air impermeable layer is preferably lower.

### Other Embodiments

The present invention is not limited to the embodiments described above but may be applied to embodiments that are modified and improved based on the knowledges of those in the art. For example, the following embodiments may be included in the technical scope of the technology described herein.

(1) In the above embodiments, the skin layer is disposed on the vehicular interior side with respect to the compressed fiber layer but the skin layer may not be included. For example, with the configuration including a member configured as a design surface of the vehicular compartment, the sound absorbing layer, the air impermeable layer, and the compressed fiber layer may be disposed on top of each other between the member and the partition member.

(2) In the above embodiments, the vehicular compartment soundproofing structure of the present invention is applied to the floor structure of an automobile; however, it is not limited thereto. The vehicular compartment soundproofing structure of the present invention may be applied to a wall of an automobile and a border section between an engine room and other member.

(3) The vehicular compartment soundproofing structure of the present invention may not be necessarily included in an automobile but may be included in various types of vehicles.

### EXPLANATION OF SYMBOLS

10 . . . vehicular floor structure (vehicular compartment soundproofing structure), 10A . . . first floor structure, 10B . . . second floor structure, 12 . . . floor panel (partition member), 14 . . . floor silencer (sound absorbing layer), 16 . . . carpet, 30 . . . air impermeable layer, 32 . . . compressed fiber layer, 32A . . . first compressed layer, 32B . . . second compressed layer, 36 . . . adhesive layer, 36A . . . first adhesive layer, 36B . . . second adhesive layer, 200 . . . vehicular floor structure, 200A . . . first vehicular floor structure, 200B . . . second vehicular floor structure, 204 . . . adhesive layer

Aa, Ab . . . area (foot space), A1 . . . first area, A2 . . . second area

1. A vehicular compartment soundproofing structure included in a vehicular compartment for suppressing exterior noise, the vehicular compartment soundproofing structure comprising:
a partition member that partitions the vehicular compartment;
a sound absorbing layer disposed on a vehicular interior side with respect to the partition member and having spaces therein;
an air impermeable layer disposed on the vehicular interior side with respect to the sound absorbing layer and made of air impermeable material; and
a compressed fiber layer disposed on the vehicular interior side with respect to the air impermeable layer and mainly formed of a compressed mass of fibers, wherein
the vehicular compartment soundproofing structure includes a first structure section in which connection strength between the air impermeable layer and the compressed fiber layer is relatively low and a second structure section in which connection strength between the air impermeable layer and the compressed fiber layer is higher the connection strength between the air impermeable layer and the compressed fiber layer of the first structure section.

2. The vehicular compartment soundproofing structure according to claim 1, wherein
the partition member is a floor panel that defines a floor of an automobile,
the first structure section is provided on a portion of the floor panel corresponding to a foot space where feet of a seated occupant are placed and the second structure section is provided on portions of the floor panel other than the foot space, and
the sound absorbing layer of the first structure section is thicker than the sound absorbing layer of the second structure section.

3. The vehicular compartment soundproofing structure according to claim 1, wherein a mass per unit area of the air impermeable layer is 15 gsm or more and 400 gsm or less and preferably 50 gsm or more and 200 gsm or less.

4. The vehicular compartment soundproofing structure according to claim 1, wherein a mass per unit area of the compressed fiber layer is 300 gsm or more and 1500 gsm or less and preferably 600 gsm or more and 1000 gsm or less.

5. The vehicular compartment soundproofing structure according to claim 1, wherein in the first structure section, the air impermeable layer and the compressed fiber layer are not bonded.

6. The vehicular compartment soundproofing structure according to claim 1, further comprising:
a first adhesive layer disposed between the air impermeable layer and the compressed fiber layer in the first structure section,
a second adhesive layer disposed between the air impermeable layer and the compressed fiber layer in the second structure section, and
the second adhesive layer has adhesion strength higher than adhesion strength of the first adhesive layer.

7. The vehicular compartment soundproofing structure according to claim 1, wherein the air impermeable layer and the sound absorbing layer are not bonded.
